(19) United States
(12) Patent Application Publication
(10) Pub. No.: US 2021/0388976 A1
(43) Pub. Date: Dec. 16, 2021

(54) LED Lamp with Built-In Power Supply

(71) Applicants: Wanjiong Lin, Ningbo (CN); Self Electronics Co., Ltd., Ningbo (CN); Self Electronics USA Corporation, Norcross, GA (US)

(72) Inventors: Chengke Zhang, Ningbo (CN); Linji Wang, Ningbo (CN); Zhaoyong Zheng, Ningbo (CN)

(73) Assignees: Wanjiong Lin; Self Electronics Co., Ltd.; Self Electronics USA Corporation

(21) Appl. No.: 17/303,192

(22) Filed: May 24, 2021

(30) Foreign Application Priority Data
Jun. 16, 2020 (CN) 202010550885.8

(51) Int. Cl. F21V 29/74; F21V 23/00; F21V 29/507; F21V 15/01

(52) U.S. Cl. CPC F21V 29/74; F21V 23/009; F21Y 2115/10; F21V 15/01; F21V 29/507

(57) ABSTRACT

An LED lamp with a built-in power supply has a lamp body, a driving power supply and a lamp panel, the lamp body having a housing in which a mounting cavity is provided, a partition is provided in the mounting cavity to divide it into an upper mounting cavity and a lower mounting cavity, and the driving power supply and the lamp panel are respectively arranged in the upper mounting cavity and the lower mounting cavity. The driving power supply and the lamp panel are respectively arranged on both sides of the partition, and the driving power supply and the partition are arranged at intervals to form an isolated cavity between the two, and the driving power supply is installed overhead, so the heat of the lamp panel and the driving power supply does not concentrate at the partition, avoiding the problem of heat not being dissipated.

### RELATED APPLICATION

This application claims priority to a Chinese Patent Application No. CN 202010550885.8, filed on Jun. 16, 2020.

### FIELD OF THE TECHNOLOGY

The invention relates to the field of lighting technology, in particular to an LED lamp with a built-in power supply.

### BACKGROUND OF THE INVENTION

In the context of energy saving and environmental protection, LED lamps are increasingly used in the home and commercial lighting fields because of their high light-emitting efficiency and good light-gathering performance. LED lamps include a lamp body and a driving power supply. The driving power supply can be built-in or external. When the driving power supply is built-in, a large amount of heat will be generated. Therefore, generally LED lamps with small size and high-power will be installed with an external driving power supply. In this way, the external power supply needs to be equipped with a special installation position, and the assembly relationship between the power supply box and the lamp body need to be ensured during assembly, resulting in a complex structure of the lamp, cumbersome assembly procedures and high assembly costs.

Although it has been exist that the driving power supply built into the lamp body at present, due to the large heat generation of the LED lamp, installing the driving power supply in the lamp body may easily lead to the problem of the driving power supply malfunctioning in a high temperature environment. Therefore, how to reasonably arrange the installation position of the driving power supply and the LED lamp in the lamp body is a technical problem urgently needed to be solved by those skilled in the art.

### BRIEF SUMMARY OF THE INVENTION

In view of this, the present invention provides an LED lamp with a built-in power supply to solve the above technical problems.

An LED lamp with a built-in power supply, comprising a lamp body, a driving power supply and a lamp panel, the lamp body comprising a housing in which a mounting cavity is provided, a partition is provided in the mounting cavity to divide it into an upper mounting cavity and a lower mounting cavity, and the driving power supply and the lamp panel are respectively arranged in the upper mounting cavity and the lower mounting cavity, the driving power supply and the partition are arranged at intervals so as to an isolation cavity is formed between them.

the driving power supply comprises a main board, and the front surface of the main board faces away from the partition.

a heat dissipation module is provided directly above the front surface of the main board.

the driving power supply further comprises a power supply box, and the main board is arranged in the power supply box, the power supply box includes a top cover opposite to the front surface of the main board, a bottom plate opposite to the back surface of the main board, and a side plate provided between the top cover and the bottom plate.

the heat dissipation module comprises a heat dissipation base arranged on the lamp body, and the bottom surface of the heat dissipation base abuts against the top cover.

a heat sink is provided on the top surface of the heat dissipation base.

the lamp panel is mounted on the partition.

a heat conducting rib is provided in the upper mounting cavity, the heat conducting rib protrudes inward from the inner wall of the housing and is abut to the side plate.

there are a plurality of heat conducting ribs arranged at intervals along the length direction of the side plate.

the isolation cavity is provided with a heat dissipation rib connecting the partition and the housing.

an overhead layer is provided between the side of the heat dissipation rib far away from the partition and the driving power supply.

the partition and the housing are made of heat conduction materials.

the edge of the partition is seamlessly connected with the inner wall of the housing.

### Technical Effects of the Present Invention

In the LED lamp with a built-in power supply of the present invention, the driving power supply and the lamp panel are respectively arranged on both sides of the partition, and the driving power supply and the partition are arranged at intervals to form an isolated cavity between the two, and the driving power supply is installed overhead, so that the heat of the lamp panel and the driving power supply does not concentrate at the partition, avoiding the problem of heat not being dissipated.

### BRIEF DESCRIPTION OF THE DRAWINGS

The embodiments of the present invention are described below in conjunction with the drawings, in which:

FIG. 1 is a schematic diagram of the structure of the LED lamp with built-in power supply of this embodiment.

FIG. 2 is a schematic diagram of the explosive structure of the LED lamp with built-in power supply.

FIG. 3 is a schematic diagram of an exploded structure of the LED lamp with built-in power supply of this embodiment from another perspective.

FIG. 4 is a schematic cross-sectional structure diagram of the LED lamp with built-in power supply of this embodiment.

FIG. 5 is a schematic diagram of the internal structure of the lamp housing of this embodiment.

FIG. 6 is a schematic diagram of the internal structure of the lamp housing (with driving power supply) of this embodiment.

### DETAILED DESCRIPTION OF THE INVENTION

Specific embodiments of the present invention will be described in further detail below based on the drawings. It should be understood that the description of the embodiments of the present invention herein is not intended to limit the protection scope of the present invention.

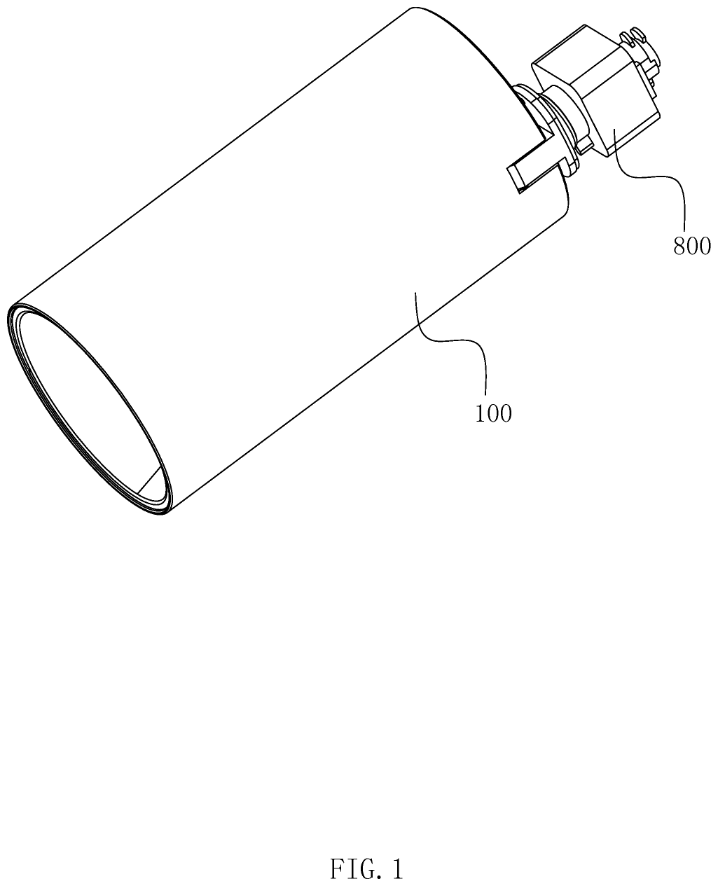

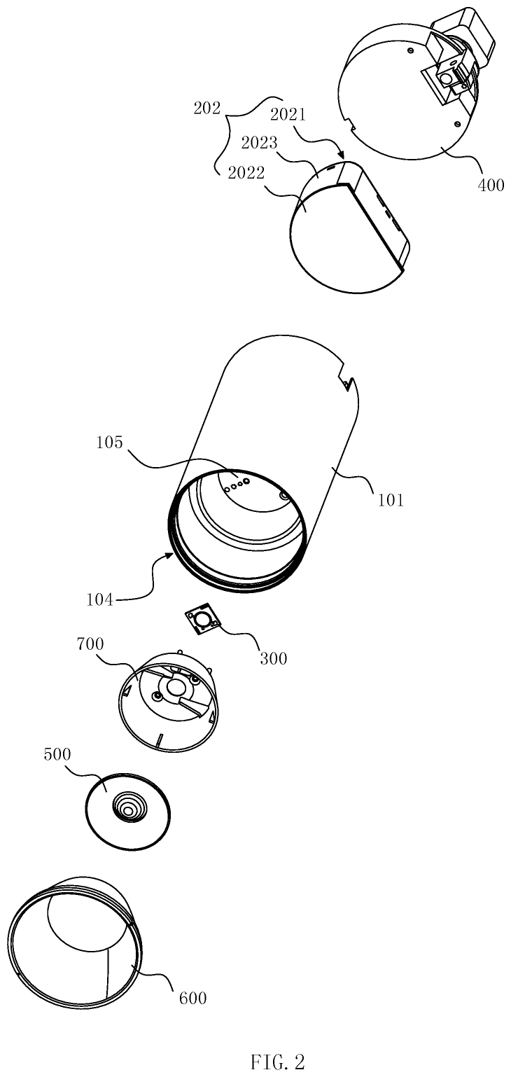

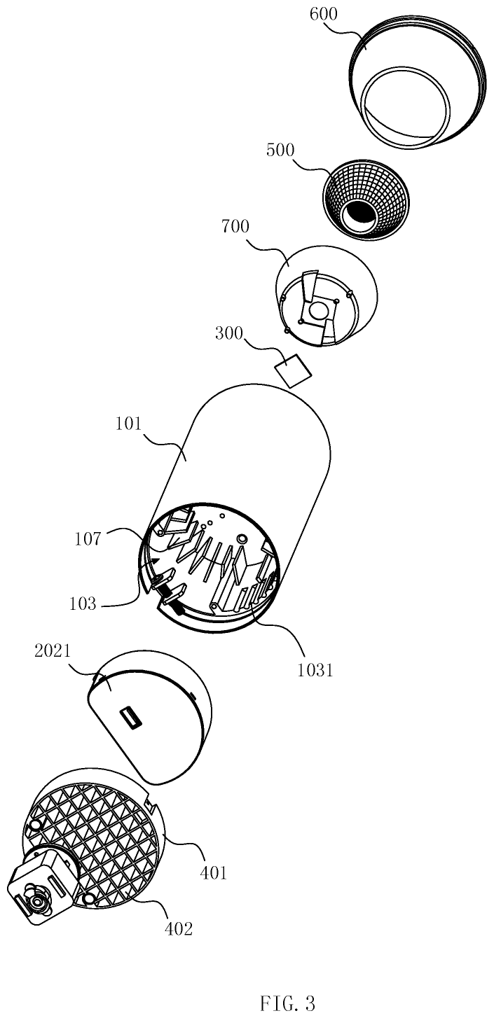

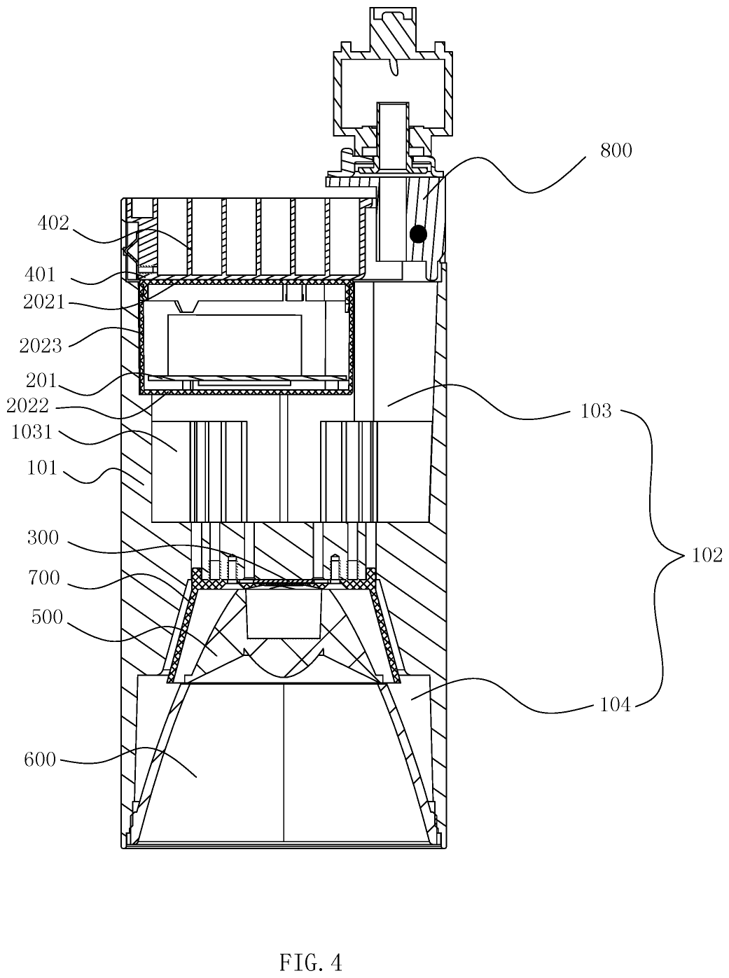

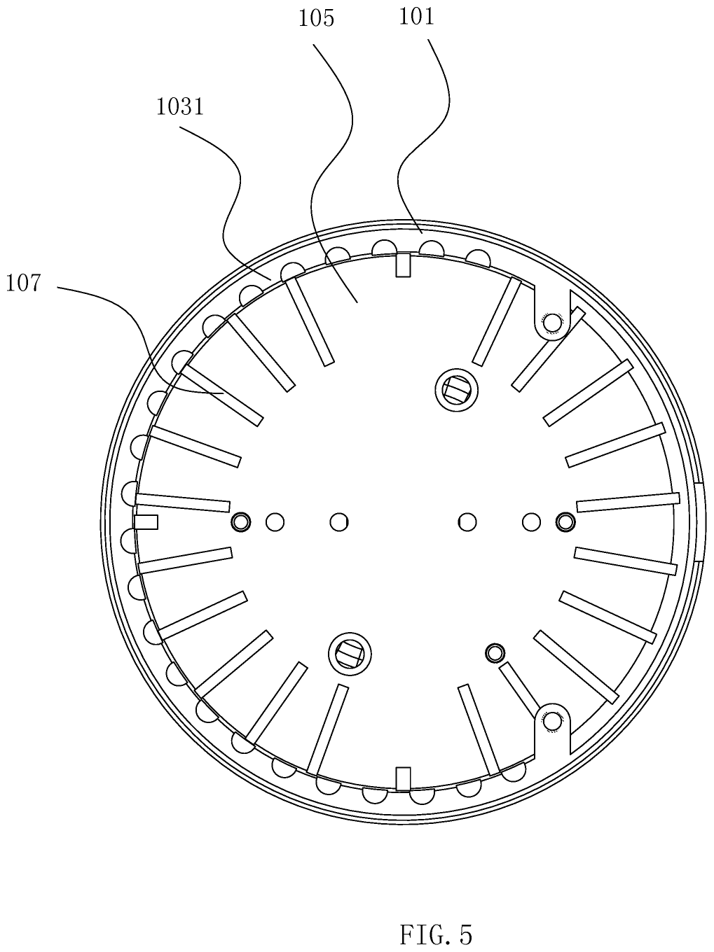

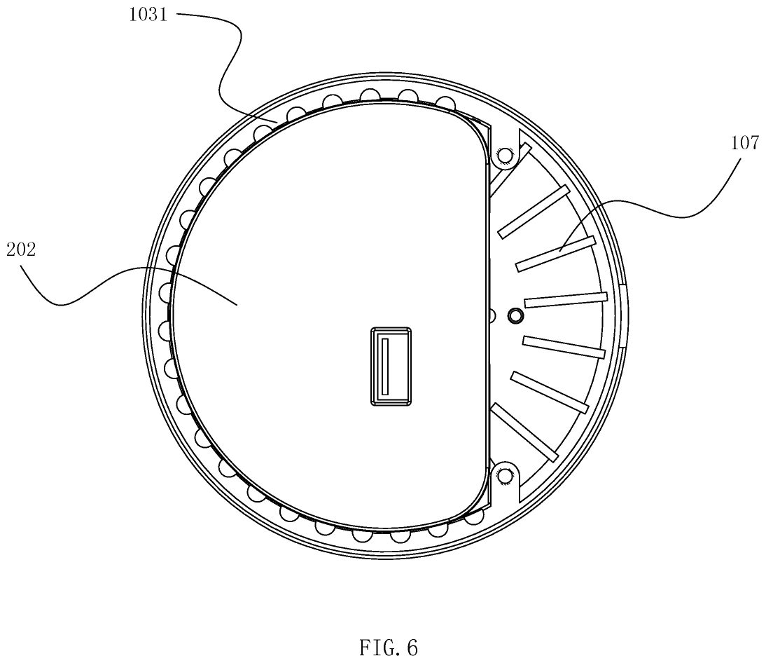

As shown in FIG. 1-6, the LED lamp with a built-in power supply of this embodiment includes a lamp body 100, a driving power supply 200, and a lamp panel 300. The lamp body 100 includes a housing 101 in which a mounting cavity 102 is provided. The mounting cavity 102 is provided with a partition 105 that divides it into an upper mounting cavity 103 and a lower mounting cavity 104. The driving power supply 200 and the lamp panel 300 are respectively arranged in the upper mounting cavity 103 and the lower mounting cavity 104. The driving power supply 200 and the partition 105 are spaced apart to form an isolation cavity 106 therebetween. The lamp panel 300 is provided with an LED chip as a light source, which will generate a lot of heat when it is lit, and many components in the driving power supply 200 will also generate a lot of heat. In this embodiment, the isolation cavity 106 is provided, so that the heat generated by the driving power supply 200 and the lamp panel 300 does not gather together to avoid the problem that the heat cannot be dissipated.

In order to prevent the heat dissipation direction of the driving power supply 200 from facing the lamp panel 300, the driving power supply 200 includes a main board 201, and the front surface of the main board 201 faces away from the partition 105. The main board 201 is used to install components which are functional modules of the drive power supply 200, including inductors, MOS tubes, transformers, common mode and rectifier diodes and other components with high heat generation, and these components are generally installed on the front of the main board 201, thereby the front side of the main board 201 is set back to the partition 105, the components in the main board 201 with higher heat generation can be turned back to the partition 105, and the heat dissipation is reversed to further avoid heat accumulation, thereby in the case of limited volume improve the heat dissipation effect.

In order to further guide the heat of the driving power supply 200 away from the lamp panel 300, in this embodiment, a heat dissipation module 400 is provided directly above the front surface of the main board 201.

In order to better distribute the heat generated by the driving power supply 200, in this embodiment, the driving power supply 200 further includes a power supply box 202, and the main board 201 is provided in the power supply box 202. The power supply box 202 comprises a top cover 2021 opposite to the front surface of the main board 201, a bottom plate 2022 opposite to the back surface of the main board 201, and a side plate 2023 provided between the top cover 2021 and the bottom plate 2022. The power supply box 202 can be made of high thermal conductivity plastic to reduce the temperature of internal components. The inner wall of the housing 101 is provided with radial protrusions to carry the power supply box 202 for fixing.

In order to better dissipate heat, in this embodiment, the heat dissipation module 400 includes a heat dissipation base 401 provided on the lamp body 100, and the bottom surface of the heat dissipation base 401 is in contact with the top cover 2021. The heat dissipation base 401 is made of a heat-conducting material, so that the heat dissipation base 401 can dissipate the heat accumulated on the top cover of the power supply box 202 as soon as possible. Furthermore, a heat sink 402 is provided on the top surface of the heat dissipation base 401. The heat sink 402 can increase the heat dissipation area and improve the heat dissipation effect. In this embodiment, the heat sink 402 is arranged in a grid to increase the heat dissipation area, and the holes in the grid provide upward channels for the driving power supply 200 to dissipate heat.

In order to quickly dissipate the heat of the lamp panel 300, in this embodiment the lamp panel 300 is mounted on the partition 105.

The driving power supply 200 can also increase the heat dissipation effect by increasing the contact area with the housing 101. In this embodiment, a heat conducting rib 1031 is provided in the upper mounting cavity 103, the heat conducting rib 1031 protrudes inward from the inner wall of the housing 101 and is abut to the side plate 2023. The side plate 2023 is generally in a surrounding form, which can be surrounded formed by multiple surfaces spliced or surrounded formed by a curved surface. It is difficult to fully contact the inner wall of the housing 101. Therefore, a heat conducting rib 1031 is provided to be attached to the side plate 2023 to increase the contact area. Preferable, there are a plurality of heat conducting ribs 1031, which are arranged at intervals along the length direction of the side plate 2023.

In order to improve the heat conduction and heat dissipation effect of the partition 105 to the lamp panel 300, in this embodiment, the isolation cavity 106 is provided with a heat dissipation rib 107 connecting the partition 105 and the housing 101. The heat dissipation ribs 107 are provided with a plurality of pieces and arranged around. The heat dissipation ribs 107 extend radially from the edge to the middle of the partition 105, and the extension length is ⅓ to ⅔ of the distance from the center of the partition 105 to the edge. The heat can be better discharged to the housing 101 through the heat dissipation ribs 107.

In order to avoid heat accumulation, in this embodiment, an overhead layer 108 is provided between the side of the heat dissipation rib 107 away from the partition 105 and the driving power supply 200. The air conduction effect is poor, and the back of the motherboard 201 is suspended to prevent heat from being transferred in this direction.

In order to improve the heat conduction effect, the partition 105 and the housing 101 are made of heat conduction materials.

In order to lead the heat of the lamp panel 300 to the housing 101 as soon as possible, in this embodiment the edge of the partition 105 is seamlessly connected with the inner wall of the housing 101. Advantageously, the housing 101 and the partition 105 are integrally formed and manufactured, and the effect of heat conduction and heat dissipation is better.

The specific application of this embodiment is more suitable for track lights. The housing of the track lights is generally cylindrical. In this embodiment, the housing 101 is a cylinder with openings 1011 at both ends, and the partition 105 is perpendicular to the central axis of the cylinder, the opening 1011 of the upper mounting cavity 103 is provided with a heat dissipation module 400 as a lamp cover. A bracket 700, a condenser lens 500 and a reflector cup 600 is also provided in the lower mounting cavity 104. The bracket 700 is used to fix the lamp panel 300, and the top of the housing 101 is also hinged with a rotating seat 800, and the rotating seat 800 is matched with a track.

In order to further improve the heat dissipation effect, in this embodiment, the thickness of the partition 105 is 5 mm to 20 mm to improve the heat storage capacity and conduct the heat of the lamp panel 300 to the lamp housing 101. The wall thickness of the housing 101 near the lamp panel 300 is larger than other positions, so as to store energy and dissipate heat.

To sum up, the heat sources of the LED lamp with built-in power supply of this embodiment are the driving power supply 200 and the lamp panel 300. The driving power supply 200 is in contact with the heat dissipation module 400 by the top and is in contact with the housing 101 by side surface or there is a small gap for heat dissipation, and the rest of the bottom is suspended except which is for positioning; the lamp panel 300 dissipates heat through contact with the partition 105, and the two do not affect each other. The heat dissipation module 400 as the top of the cover has a grid shape, which provides an upward channel for the heat dissipation of the driving power supply 200. The housing 101 is closely attached to the side plate of the driving power supply 200 to increase the heat dissipation area. The wall thickness of the housing 101 in the contact area with the lamp panel 300 is increased to increase heat storage, and the heat sink structure on the reverse side is to increase the heat dissipation area.

The above are only preferred embodiments of the present invention, and are not used to limit the protection scope of the present invention. Any modification, equivalent replacement or improvement within the spirit of the present invention is covered by the scope of the claims of the present invention.

What is claimed is:

1. An LED lamp with a built-in power supply, comprising a lamp body (100), a driving power supply (200) and a lamp panel (300), the lamp body (100) comprising a housing (101) in which a mounting cavity 102 is provided, a partition (105) is provided in the mounting cavity (102) to divide it into an upper mounting cavity (103) and a lower mounting cavity (104), and the driving power supply (200) and the lamp panel (300) are respectively arranged in the upper mounting cavity (103) and the lower mounting cavity (104), characterized in that the driving power supply (200) and the partition (105) are arranged at intervals so as to an isolation cavity (106) is formed between them.

2. The LED lamp with a built-in power supply as claimed in claim 1, wherein the driving power supply (200) comprises a main board (201), and the front surface of the main board (201) faces away from the partition (105).

3. The LED lamp with a built-in power supply as claimed in claim 2, wherein a heat dissipation module (400) is provided directly above the front surface of the main board (201).

4. The LED lamp with a built-in power supply as claimed in claim 3, wherein the driving power supply (200) further comprises a power supply box (202), and the main board (201) is arranged in the power supply box (202), the power supply box (202) includes a top cover (2021) opposite to the front surface of the main board (201), a bottom plate (2022) opposite to the back surface of the main board (201), and a side plate (2023) provided between the top cover (2021) and the bottom plate (2022).

5. The LED lamp with a built-in power supply as claimed in claim 4, wherein the heat dissipation module (400) comprises a heat dissipation base (401) arranged on the lamp body (100), and the bottom surface of the heat dissipation base (401) abuts against the top cover (2021).

6. The LED lamp with a built-in power supply as claimed in claim 5, wherein a heat sink (402) is provided on the top surface of the heat dissipation base (401).

7. The LED lamp with a built-in power supply as claimed in claim 1, wherein the lamp panel (300) is mounted on the partition (105).

8. The LED lamp with a built-in power supply as claimed in claim 1, wherein a heat conducting rib (1031) is provided in the upper mounting cavity (103), the heat conducting rib (1031) protrudes inward from the inner wall of the housing (101) and is abut to the side plate (2023).

9. The LED lamp with a built-in power supply as claimed in claim 7, wherein there are a plurality of heat conducting ribs (1031) arranged at intervals along the length direction of the side plate (2023).

10. The LED lamp with a built-in power supply as claimed in claim 1, wherein the isolation cavity (106) is provided with a heat dissipation rib (107) connecting the partition (105) and the housing (101).

11. The LED lamp with a built-in power supply as claimed in claim 10, wherein an overhead layer (108) is provided between the side of the heat dissipation rib (107) far away from the partition (105) and the driving power supply (200).

12. The LED lamp with a built-in power supply as claimed in claim 1, wherein the partition (105) and the housing (101) are made of heat conduction materials.

13. The LED lamp with a built-in power supply as claimed in claim 1, wherein the edge of the partition (105) is seamlessly connected with the inner wall of the housing (101).

14. The LED lamp with a built-in power supply as claimed in claim 1, wherein the housing (101) is a cylinder with openings (1011) at both ends, and the partition (105) is perpendicular to the central axis of the cylinder, the opening (1011) of the upper mounting cavity (103) is provided with a heat dissipation module (400) as a lamp cover.
